(19) United States
(12) Patent Application Publication
(10) Pub. No.: US 2015/0316656 A1
(43) Pub. Date: Nov. 5, 2015

(54) METHOD FOR DETERMINING THE POSITION OF A SATELLITE NAVIGATION SYSTEM RECEIVER, AND ASSOCIATED SYSTEM

(71) Applicant: THALES, Courbevoie (FR)

(72) Inventors: Thibaud CALMETTES, MONTGISCARD (FR); Guillaume CARRIE, GREPIAC (FR); Damien KUBRAK, TOULOUSE (FR)

(21) Appl. No.: 14/699,275

(22) Filed: Apr. 29, 2015

(30) Foreign Application Priority Data
Apr. 30, 2014 (FR) 1401008

(51) Int. Cl. G01S 19/42

(52) U.S. Cl. CPC G01S 19/42

(57) ABSTRACT

A method is provided for determining the position of a satellite navigation system receiver in which use is made of a probabilistic weighting of the signals received, the weighting using a coefficient Kᵢ, for each satellite of index i, the coefficient Kᵢ being a product of factors each comprising a probability of existence of a disturbance, the coefficient Kᵢ, for each satellite of index i, comprising at least one factor of the form (1−Pⱼⁱ)^{a}^{ᵢ}.

### CROSS-REFERENCE TO RELATED APPLICATION

This application claims priority to foreign French patent application No. FR 1401008, filed on Apr. 30, 2014, the disclosure of which is incorporated by reference in its entirety.

### FIELD OF THE INVENTION

The invention pertains to a method for determining the position of a satellite navigation system receiver, and to an associated system.

### BACKGROUND

It is important to improve the robustness of satellite navigation systems with high integrity constraint to intentionally or unintentionally disturbed radio-electrical environments. This relates in particular to land, rail and air transport applications.

It is known to introduce “margins” on the position uncertainty region, notably for a space augmentation system or SBAS, the acronym standing for “satellite-based augmentation system” for aviation.

This approach is satisfactory only in relatively open (few masks) and weakly disturbed environments, but not in more critical environments.

It is also known to employ rejections, for example in the case of algorithms for detection and rejection of multi-paths in ground environments, in mono or multi-antenna mode, and in mono or multi-constellation mode.

This approach exhibits the difficulty of leading to high ambiguity between noise and disturbance, it does not really allow fine characterization of the perturbations, and the simple rejection approach, notably in the case of a false alarm, may create problems of availability.

### SUMMARY OF THE INVENTION

An aim of the invention is to alleviate the drawbacks cited above.

An aim of the invention is to improve the robustness of satellite navigation systems.

Hence, there is proposed, according to an aspect of the invention, a method for determining the position of a satellite navigation system receiver in which use is made of a probabilistic weighting of the signals received, the said weighting using a coefficient Kᵢ, for each satellite of index i, the said coefficient Kᵢ being a product of factors each comprising a probability of existence of a disturbance, the said coefficient Kᵢ being a product of factors each comprising a probability of existence of a disturbance, the said coefficient Kᵢ, for each satellite of index i, comprising at least one factor of the form (1−pⱼⁱ)^{a}^{ᵢ}, j varying from 1 to 6 in which:

P₁ⁱ represents, for the satellite of index i, a first probability that the signal received comprises a combination of a non-reflected signal component and of a multi-path signal component,
P₂ⁱ represents, for the satellite of index i, a second probability that the signal received comprises solely a multi-path signal component,
P₃ⁱ represents, for the satellite of index i, a third probability that the signal received is jammed by terrestrial interference,
P₄ⁱ represents, for the satellite of index i, a fourth probability that the signal received comprises a combination of a component of a signal generated by a jammer on the ground and of a component of the nominal signal,
P₅ⁱ represents, for the satellite of index i, a fifth probability that the signal received is not in coherence with previous conditions of reception of the said signal,
P₆ⁱ represents, for the satellite of index i, a sixth probability that the signal received is not in coherence with a mapping of the environs, and
aᵢ represents a positive real.

Thus, it is possible to take simple and effective account of disturbance models in the resolution of the position of the receiver, by evaluating the probability of disturbance, and to integrate these models automatically in the position calculation and in the integrity calculation.

A weighting Kᵢ of this form makes it possible to concatenate in one and the same formulation the information on all the sources of disturbances that can be identified, thereby allowing its simple use by brute rejection and/or by measurement weighting such as seen hereinabove. Another advantage is of being cumulative, and therefore of allowing phenomena which are fuzzy or hard to identify to be taken into account: even if the calculation of the probabilities does not allow a type of disturbance to be revealed for definite (no probability is equal to 100%), several indicators may be disturbed (several Pⱼⁱ (jε[[1;6]]) will be above 0%) and therefore the overall score Kᵢ may nevertheless be restricted.

In an embodiment, when a coefficient Kᵢ is below a first threshold, the said determination of the position of the satellite navigation system receiver discards the signals received from the satellite of index i.

Thus, it is possible to eliminate signals for which the disturbance is considered definite or quasi-definite.

According to one embodiment, the said determination of the position of the satellite navigation system receiver uses a weighting of the measurements of the signals emitted by the said satellites of respective value 1/Kᵢ.

Thus, the measurements that are most probably undisturbed are favoured by the location processing in the resolution of the point or position of the receiver. Furthermore, the sum of the weightings over all the satellites used contributes to the creation of a confidence level, used notably to establish integrity. By integrating these values 1/Kᵢ which are necessarily greater than or equal to 1, the sum of the weightings is increased, as is therefore the confidence level for taking into account the probability of disturbance as soon as the latter is non-zero.

In one embodiment, the first probability P₁ⁱ, for the satellite of index i, that the signal received comprises a combination of a non-reflected signal component and of a multi-path signal component, simultaneously uses a delay tracking loop based on a narrow separation early/late discriminant, a delay tracking loop based on a normal separation early/late discriminant, and a discrepancy between the lags evaluated by the said loops.

Thus, if the multi-path is bigger than the separation of the narrow separation early/late discriminant, a difference appears between the two outputs or two trackings: the narrow tracking will continue to follow the direct path, whereas the normal tracking will see a combination of the direct path and of the reflected path. If the multi-path is smaller than the separation of the narrow separation early/late discriminant, the detection will not work since the two trackings are affected alike, but in order to limit this effect, a sufficiently small narrow separation is considered, such that the impact of the multi-path is acceptable (typically less than a metre). This measurement of the discrepancy between the two trackings does therefore actually make it possible to construct a metric for the detection of the multi-paths with direct signal.

The early/late discriminant corresponds to the difference between the correlation at an instant in advance with respect to the signal and the correlation at an instant delayed with respect to the signal. It makes it possible to track the evolution of the synchronization and corresponds to the measurement of the tempo tracking loop (or DLL, the acronym standing for “Delay Locked Loop”). In a conventional manner, a separation of the two correlations (either in advance, or delayed) of half a chip is considered, since this offers the best performance in a Gaussian environment. However, in the case notably of multi-paths which may add a contribution between 0 and 0.5 chips, then the discriminant applied for a smaller separation of the two correlations (either in advance, or delayed), for example of 0.1 chips, might also be of interest. If a noticeable difference appears between the two, this is a priori the sign of a multi-path of offset between 0.1 chips and 0.5 chips which affects the conventional early/late discriminant on 0.5 chips but not the restricted early/late discriminant on 0.1 chips.

According to one embodiment, the second probability P₂ⁱ, for the satellite of index i, that the signal received comprises solely a multi-path signal component, simultaneously uses a delay tracking loop based on a narrow separation early/late discriminant, a delay tracking loop based on a normal separation early/late discriminant, and a temporal variation of a discrepancy between the lags evaluated by the said loops.

Thus, in contradistinction to P₁ⁱ, there is no direct path, so that there is no longer any useful signal in the interval observed by the narrow separation discriminant. The associated tracking ends up diverging, while the normal separation discriminant remains locked onto the multi-path. Hence, a metric associated with the relative dropout of lock actually makes it possible to account for the disturbance.

In one embodiment, the third probability P₃ⁱ, for the satellite of index i, that the signal received is jammed by terrestrial interference uses a discrepancy between a measurement of the ratio of the power of the useful signal received to the power of the noise in the signal received and an expected estimation of the ratio of the power of the useful signal received to the power of the noise in the signal received. A decrease in the signal-to-noise ratio may originate either from interference, or from masking or some other attenuation. It is then possible to improve the model of the said expected estimation by including in the latter the maskings and other attenuations known through mapping (notably 3D).

Thus, it is possible to observe a decrease in the signal-to-noise ratio originating from interference.

According to one embodiment, the fourth probability P₄ⁱ, for the satellite of index i, that the signal received comprises a combination of a component of a signal generated by a jammer on the ground and of a component of the nominal signal uses a discrepancy between a measurement of pseudo-distance residual and an expected estimation of pseudo-distance residual.

It is thus possible to observe the incoherence, in absolute value (bias), of a signal with respect to the estimated location.

According to one embodiment, the fifth probability P₅ⁱ, for the satellite of index i, that the signal received is not in coherence with previous conditions of reception of the said signal uses a variation of the variance of the residuals of the pseudo-distances of the said satellites.

It is thus possible to observe the incoherence over time, or noise, of a signal with respect to the estimated location. Two suspect cases exist:
either the variance decreases strongly, and this signifies:
   either that the signal was disturbed by a diffuse multi-path and that it has passed to a reflected multi-path: a very frequent case in urban environments.
   or that the signal was received under slightly noisy “normal” conditions, but that it is now received under perfect conditions, as could be generated by a decoy.
or the variance increases strongly, thereby signifying entry into a disturbed environment.

In one embodiment, the sixth probability P₆ⁱ, for the satellite of index i, that the signal received is not in coherence with a mapping of the environs uses a discrepancy between the measured power of the signal received from the satellite of index i and an expected estimation of the power of the signal received from the satellite of index i.

Thus, by considering the power, it is advantageously possible to take account of effects of overly high levels received (the signals ought to be received masked but are not (position error)), or to take account of signals which ought to be received overly weak and in place of which a spoofer is received, or to take account of effects of overly low levels received (the signals ought not to be received masked but are (position error)).

According to another aspect of the invention, there is also proposed a system for determining the position of a system receiver of a satellite navigation system, adapted for implementing the method such as described above.

### BRIEF DESCRIPTION OF THE DRAWINGS

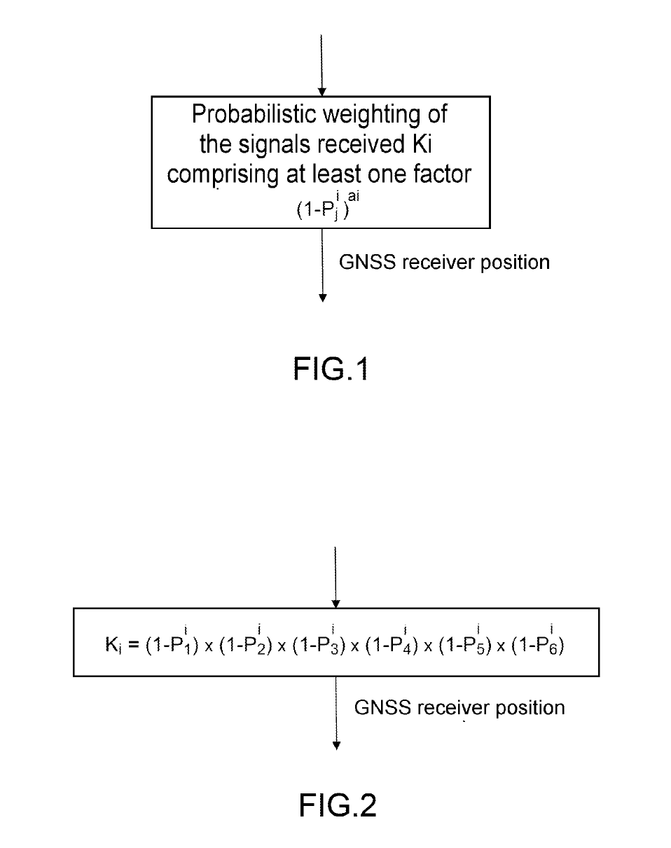

The invention will be better understood on studying a few embodiments described by way of wholly non-limiting examples and illustrated by the appended drawings which FIGS. 1 and 2 schematically illustrate.

### DETAILED DESCRIPTION

There is proposed, as illustrated in FIG. 1, according to an aspect of the invention, a method for determining the position of a satellite navigation system receiver in which use is made of a probabilistic weighting of the signals received, the said weighting using a coefficient Kᵢ, for each satellite of index i, the said coefficient Kᵢ being a product of factors each comprising a probability of existence of a disturbance, the said coefficient Kᵢ, for each satellite of index i, comprising at least one factor of the form (1−Pⱼⁱ)^{a}^{ᵢ}, j varying from 1 to 6 in which:

P₁ⁱ represents, for the satellite of index i, a first probability that the signal received comprises a combination of a non-reflected signal component and of a multi-path signal component,
P₂ⁱ represents, for the satellite of index i, a second probability that the signal received comprises solely a multi-path signal component,
P₃ⁱ represents, for the satellite of index i, a third probability that the signal received is jammed by terrestrial interference,
P₄ⁱ represents, for the satellite of index i, a fourth probability that the signal received comprises a combination of a component of a signal generated by a jammer on the ground and of a component of the nominal signal,
P₅ⁱ represents, for the satellite of index i, a fifth probability that the signal received is not in coherence with previous conditions of reception of the said signal,
P₆ⁱ represents, for the satellite of index i, a sixth probability that the signal received is not in coherence with a mapping of the environs, and
aᵢ represents a positive real.

Typically, aᵢ is a positive real lying between 0 and 3.

The weighting, as illustrated in FIG. 2, can use a coefficient Kᵢ, for each satellite of index i, of the following form:

Kᵢ=(1−P₁ⁱ)×(1−P₂ⁱ)×(1−P₃ⁱ)×(1−P₄ⁱ)×(1−P₅ⁱ)×(1−P₆ⁱ)

(the aᵢ are all equal to 1 in this case)

Of course, as a variant, the coefficient Kᵢ can comprise just some of the factors of the above relation.

When a coefficient Kᵢ is below a first threshold S₁, the determination of the position of the satellite navigation system receiver discards the signals received from the satellite of index i. This makes it possible to eliminate signals for which the disturbance is considered definite or quasi-definite.

The determination of the position of the satellite navigation system receiver uses a weighting of the measurements of the signals emitted by the said satellites of respective value 1/Kᵢ.

The first probability P₁ⁱ, for the satellite of index i, that the signal received comprises a combination of a non-reflected signal component and of a multi-path signal component, simultaneously uses a delay tracking loop based on a narrow separation early/late discriminant, a delay tracking loop based on a normal separation early/late discriminant, and a discrepancy between the lags evaluated by the said loops.

For example, the first probability P₁ⁱ may, for example, be defined by the following relations:

$$\{ \begin{matrix}if Abs ( {DLL}_{narrow } - {DLL}_{normal} ) \geq a chips , \\ then {P}_{1} = 0 \\ if Abs ( {DLL}_{narrow} - {DLL}_{normal} ) < a chips , \\ then {P}_{1} = {C}_{1} \times Abs ( {DLL}_{narrow} - {DLL}_{normal} ) / a\end{matrix}$$

in which:
DLL_{narrow} represents the synchronization estimated by the narrow delay tracking loop, in s,
DLLₙₒᵣₘₐₗ represents the synchronization estimated by the normal delay tracking loop, in s,
a represents a coefficient of separation of the loops DLL_{narrow} and DLLₙₒᵣₘₐₗ, in chips, lying between 0 and 1, equal to 0.5 chips for example,
C₁ represents a dimensionless first coefficient lying between 0.8 and 1, that may equal 0.9 for a setting of the first rejection threshold S1 of the measurements to 0.1,
and 1 chip represents the time interval between two successive bits of the spread spectrum code of the satellite navigation system, in s.

The symbol Abs represents of course the absolute value function.

The first probability P₁ⁱ conveys a case in which the nominal signal is received under good conditions, and that it is then possible to replace the conventional correlator for which the distance between the correlation points is half a chip by a narrow correlator, for which the distance between the correlation points may be shorter, for example 0.1 chips. The difficulty with the narrow correlator is that it is more sensitive to thermal noise, so that it is not generally used, but in general it succeeds in tracking a direct signal. The main interest is that if the reflected signal is received with a time offset equivalent to 0.4 chips, it is seen in the 0.5 chip normal correlator, but it is not seen by the 0.1 chip narrow correlator. Thus, it is possible to convey the probability of being in the case of a direct signal and in a reflected signal through the distancing of the DLL code loop on the narrow correlator DLL_{narrow} and the code loop on the normal correlator DLLₙₒᵣₘₐₗ.

The second probability P₂ⁱ that the signal received comprises solely a multi-path signal component may, for example, be defined by the following relations:

$$\{ \begin{matrix}if Abs ( {DLL}_{narrow} - {DLL}_{normal} ) < b chips , \\ then {P}_{2} = 0 \\ if Abs ( {DLL}_{narrow} - {DLL}_{normal} ) > 1 chip , \\ then {P}_{2} = {C}_{2} \\ else {P}_{2} = {C}_{2} \times ( Abs ( {DLL}_{narrow} - {DLL}_{normal} ) - b ) / b\end{matrix}$$

in which:
b represents a coefficient of separation of the loops DLL_{narrow} and DLLₙₒᵣₘₐₗ, in chips, lying between 0 and 1, equal to 0.5 chips for example,
C₂ represents a dimensionless second coefficient lying between 0.8 and 1, that may equal 0.9 for a setting of the first threshold S1 for rejecting the measurements S1 to 0.1.

The second probability P₂ⁱ conveys the fact that the narrow discriminant no longer receives the direct signal. Provided that the jump between the former direct signal and the reflected signal is sufficiently large (if it is sufficiently small, the impact on the positioning is negligible), the loop over the discriminant will drop out of lock, and therefore provide an arbitrary value without any relationship to the signal received. On the contrary, for the normal discriminant, the jump is small and lock-on and tracking are done on the reflected signal.

The third probability P₃ⁱ that the signal received is jammed by terrestrial interference may, for example, be defined by the following relations:

$$\{ \begin{matrix}{if ( S / {N}_{0} )}_{measured} > {( S / {N}_{0} )}_{expected} - c , \\ then {P}_{3} = 0 \\ {if ( S / {N}_{0} )}_{measured} < {( S / {N}_{0} )}_{expected} - d , \\ then {P}_{3} = {C}_{3} \\ else {P}_{3} = {C}_{3} \times ( {( S / {N}_{0} )}_{expected} - {( S / {N}_{0} )}_{measured} - c ) / ( d - c )\end{matrix}$$

in which:
c represents a signal-to-noise ratio coefficient, in dB, lying between 0.5 dB and 10 dB, equal to 2 dB for example,
d represents a signal-to-noise ratio coefficient, in dB, lying between 3 dB and 20 dB, equal to 10 dB for example,
S represents the power of the signal received, in w,
N₀ represents the power of the noise in the signal received, in w, and
C₃ represents a dimensionless third coefficient lying between 0.8 and 1, that may equal 0.9 for a setting of the first threshold S1 for rejecting the measurements to 0.1.

The third probability P₃ⁱ uses an estimation (S/N₀)_{expected} of the signal-to-noise ratio by considering the reception geometry, knowing the approximate position of the receiver, the position of the satellite, and if possible a coarse element for anticipating the maskings. This estimated signal-to-noise ratio (S/N₀)_{expected} is compared with the measured signal-to-noise ratio (S/N₀)_{measured}, the latter being obtained by the conventional techniques for measuring signal-to-noise ratio S/N₀ while tracking on GNSS signals, for example by verifying the stability of the tracking loops (the values of S/N₀ are in dB), and a check is conducted to verify whether the signal-to-noise ratio (S/N₀)_{measured} is not much lower than expected.

The fourth probability P₄ⁱ that the signal received comprises a combination of a component of a signal generated by a jammer on the ground and of a component of the nominal signal may, for example, be defined by the following relations:

$$\{ \begin{matrix}if Abs ( {R}_{exp} ( t , i ) - {R}_{obs} ( t , i ) ) < e \times Abs ( {R}_{exp} ( {t}_{ref} , i ) - {R}_{obs} ( {t}_{ref} , i ) ) , \\ then {P}_{4} = 0 \\ if Abs ( {R}_{exp} ( t , i ) - {R}_{obs} ( t , i ) ) > f \times Abs ( {R}_{exp} ( {t}_{ref} , i ) - {R}_{obs} ( {t}_{ref} , i ) ) , \\ then {P}_{4} = {C}_{4} \\ else {P}_{4} = {C}_{4} \times ( \frac{Abs ( {R}_{exp} ( t , i ) - {R}_{obs} ( t , i ) )}{Abs ( {R}_{exp} ( {t}_{ref} , i ) - {R}_{obs} ( {t}_{ref} , i ) )} - e ) / ( f - e )\end{matrix}$$

in which:
Rₑₓₚ(t,i) represents the residual of the expected pseudo-distance for satellite i at the instant t, in km,
R_{obs}(t,i) represents the measured pseudo-distance for satellite i at the instant t, in km,
t_{ref} represents a reference instant prior to the instant t,
e represents a dimensionless comparison coefficient lying between 1 and 10, equal to 3 for example,
f represents a dimensionless comparison coefficient lying between 3 and 20, equal to 10 for example,
and
C₄ represents a dimensionless fourth coefficient lying between 0.8 and 1, that may equal 0.9 for a setting of the first threshold S1 for rejecting the measurements to 0.1.

A pseudo-distance residual is the difference between the measured pseudo-distance and the pseudo-distance calculated in accordance with the estimated position of the receiver and the position of the satellite known through its ephemerides.

The fourth probability P₄ⁱ conveys the fact that the signal received remains strong, therefore not detectable by the third probability P₃ⁱ, but that this is not the appropriate one. The fourth probability P₄ⁱ proposes to focus on an implementation which is a comparison with an inertial location, a technique used in the civil sector, such as Ecotax boxes to give a specific example. It is possible to consider that the expected position Pₑₓₚ(t) at an instant t is given by the propagation of the inertial measurements of a reference position established (by combining GNSS (for example GPS) and Inertia) at a reference instant t_{ref} prior to t, for example t_{ref}=t−10 s. On the basis of this expected position Pₑₓₚ(t), and knowing the position of the satellite i through its ephemerides, it is possible to calculate the measurement of expected pseudo-distance Rₑₓₚ(t,i) for this satellite i at the instant t, and compare it with the observed or measured measurement R_{obs}(t,i) for satellite i at the instant t. This comparison or difference is called the innovation, more precisely the opposite, namely the measured value from which the expected value is subtracted. It is also possible to make this same comparison at the moment t_{Ref}. If the innovation is low and especially if it drifts slowly between t_{Ref} and t, it is not suspect, since the GNSS measurements are affected by noise type errors, and the inertial propagations are affected by drift type errors. If on the other hand, suddenly, the difference becomes large and/or the drift becomes high, this certainly becomes a problem.

The fifth probability P₅ⁱ that the signal received is not in coherence with previous conditions of reception of the said signal may, for example, be defined by the following relations:

$$\{ \begin{matrix}if V ( t , i ) < g \times V ( t - {t}_{1} , i ) , \\ then {P}_{5} = 0 \\ if V ( t , i ) > h \times V ( t - {t}_{1} , i ) , \\ then {P}_{5} = {C}_{5} \\ else {P}_{5} = {C}_{5} \times ( V ( t , i ) / V ( t - {t}_{1} , i ) - g ) / ( h - g )\end{matrix}$$

in which:
t₁ represents a duration, in s,
V(t,i) represents the variance of the residuals of the pseudo-distances of the said satellites between the instant t−Dt and t, Dt being the interval for calculating the variance, for example 10 s and
g represents a dimensionless comparison coefficient lying between 1 and 10, equal to 3 for example,
h represents a dimensionless comparison coefficient lying between 3 and 20, equal to 10 for example,
C₅ represents a dimensionless fifth coefficient lying between 0.8 and 1, that may equal 0.9 for a setting of the first threshold S1 for rejecting the measurements to 0.1.

The fifth probability P₅ⁱ considers the same basic metric as the fourth probability P₄ⁱ, namely the innovation of the measurements of pseudo-distances with respect to an expected position established by GNSS and inertia. On the other hand, in the fifth probability P₅ⁱ, a longer-term behaviour is of interest, with, for example, the variance of the innovation over a minute. The variance in the innovation for all the measurements made between t−60 s and t is thus called V(t, i), knowing for example that one measurement per second is considered (t₁ may equal 60 s for example).

The sixth probability P₆ⁱ that the signal received is not in coherence with a mapping of the environs is defined by the following relations:

$$\{ \begin{matrix}if Abs ( {P}_{measured} - {P}_{expected} ) < k , \\ then {P}_{6} = 0 \\ if Abs ( {P}_{measured} - {P}_{expected} ) > l , \\ then {P}_{6} = {C}_{6} \\ else {P}_{6} = ( Abs ( {P}_{measured} - {P}_{expected} ) - k ) / ( l - k )\end{matrix}$$

in which:
P_{measured} represents the measured power of the signal received, in W,
P_{expected} represents the expected power of the signal received, in W,
k represents a power coefficient, in dBW, lying between 0.5 dBW and 3 dBW, equal to 2 dBW for example,
l represents a power coefficient, in dBW, lying between 0.5 dBW and 3 dBW, equal to 2 dBW for example,
C₆ represents a dimensionless sixth coefficient lying between 0.8 and 1, that may equal 0.9 for a setting of the first threshold S1 for rejecting the measurements to 0.1.

For the sixth probability P₆ⁱ, it is considered that a complete 3D mapping is employed in order to be able to really precisely estimate the expected power P_{expected} of the signal. This estimation depends on the angle of elevation of the satellite. This measurement is compared (a little as in the third probability P₃ⁱ) with a power measurement on the signal P_{measured}. The difference with the third probability P₃ⁱ is on the one hand that the power rather than the signal-to-noise ratio is considered, and on the other hand that positive errors are also considered suspect: if the expected power P_{expected} is lower than the measured power P_{measured}, this signifies that there is an incoherence (in the position, in the mapping, or in the origin of the signal), and therefore a risk.

For exemplary illustration, an example with seven visible satellites, numbered from 1 to 7, is considered.

On satellite 1, there exists very strong noise with respect to the expected signal at the current instant, the remainder being normal: P₃ⁱ=0.9; P₁ⁱ=P₂ⁱ=P₄ⁱ=P₅ⁱ=P₆ⁱ=0. The value of the weighting K for satellite i is denoted K. We therefore have K1=0.1.

On satellite 2, there exists a multi-path with direct line, the reflected signal being of fairly low power, the remainder being normal: P₃ⁱ=0.5, P₁ⁱ=0.1 (slight contribution of the multi-path to the noise), P₅ⁱ=0.1 (the variance over the current minute where the multi-path is present is higher than that before where it is assumed that the multi-path was absent (the case of a car in town for example)), P₂ⁱ=P₄ⁱ=P₆ⁱ=0. We then have K₂=0.5×1×0.9×1×0.9×1=0.405.

Satellite 3 is not a true satellite, but a jammer: P₁ⁱ=P₂ⁱ=P₃ⁱ=0; P₅ⁱ=0 (it is considered that the jammer has been there for more than a minute); P₄ⁱ=0.8 (the jammer is seen well by P₄ⁱ) and P₆ⁱ=0.5 (the emitter of the jammer has contrived matters so that the signal-to-noise ratio S/N₀ is appropriate (P₃ⁱ does not see it), but the power itself is too high). K₃=0.2×0.5=0.1.

Satellite 4 is affected by an ionospheric bubble, and the current measurement is degraded in terms of pure delay. P₁ⁱ=P₂ⁱ=P₃ⁱ=P₆ⁱ=0. The bubble being short in time (let us say 10 s), it hardly affects the variance averaged over the whole of the last minute (P₅ⁱ=0.3), but it is more visible by comparison with the previous measurement (P₄ⁱ=0.5). K₄=0.5×0.7=0.35.

The other satellites are not disturbed.

The work is carried out in two steps:

If Kᵢ<0.15, the satellite is completely eliminated: satellites 1 and 3 are therefore eliminated.

For the other satellites, a weighting of the complementary measurements in proportion to Kᵢ is considered: for each satellite, a value of estimated measurement noise sigmaError(i) is calculated, for example according to the MOPS equations, the acronym standing for Minimum Operational Performance Standards (standard for use of GNSS in civil aviation). Normally, according to MOPS, the position is thereafter solved by least squares by weighting each pseudo-distance of satellite i by the estimated measurement noise sigmaError(i). The protection level is calculated likewise by adding together the geometric projection (North, East, Vertical) on the position of these sigmaError(i). According to the invention, the same principle is retained, but replacing sigmaError(i) by a value of estimated measurement noise weighted by the probability of disturbance sigmaErrorDisturbance (i), given by the equation sigmaErrorDisturbance(i)=sigmaError(i)/Kᵢ. Thus, in the present example, sigmaError(i) is retained for satellites 5, 6 and 7, but that of satellite 2 is multiplied by 1/K₂=2.47 and that of satellite 4 by 1/K₄=2.86.

Stated otherwise, the values of the signals of the satellites whose coefficients Kᵢ are retained is weighted by a factor 1/Kᵢ.

There is also proposed a system for determining the position of a system receiver of a satellite navigation system, adapted for implementing the method such as described above.

The steps of the above-described method can be performed by one or more programmable processors for executing a computer program so as to execute the functions of the invention by operating on input data and generating outputs.

A computer program can be written in any form of programming language, including compiled or interpreted languages, and the computer program can be deployed in any form, including as an autonomous program or as a subprogram, the element or other unit suitable for use in a calculation environment.

1. A method for determining the position of a satellite navigation system receiver in which use is made of a probabilistic weighting of the signals received, the said weighting using a coefficient Kᵢ, for each satellite of index i, the said coefficient Kᵢ being a product of factors each comprising a probability of existence of a disturbance, the said coefficient Kᵢ, for each satellite of index i, comprising at least one factor of the form (1−Pⱼⁱ)^{a}^{ᵢ}, j varying from 1 to 6 in which:
P₁ⁱ represents, for the satellite of index i, a first probability that the signal received comprises a combination of a non-reflected signal component and of a multi-path signal component,
P₂ⁱ represents, for the satellite of index i, a second probability that the signal received comprises solely a multi-path signal component,
P₃ⁱ represents, for the satellite of index i, a third probability that the signal received is jammed by terrestrial interference,
P₄ⁱ represents, for the satellite of index i, a fourth probability that the signal received comprises a combination of a component of a signal generated by a jammer on the ground and of a component of the nominal signal,
P₅ⁱ represents, for the satellite of index i, a fifth probability that the signal received is not in coherence with previous conditions of reception of the said signal,
P₆ⁱ represents, for the satellite of index i, a sixth probability that the signal received is not in coherence with a mapping of the environs, and
aᵢ represents a positive real.

2. The method according to claim 1, in which, when a coefficient Kᵢ is below a first threshold (S₁), the said determination of the position of the satellite navigation system receiver discards the signals received from the satellite of index i.

3. The method according to claim 1, in which the said determination of the position of the satellite navigation system receiver uses a weighting of the measurements of the signals emitted by the said satellites of respective value 1/Kᵢ.

4. The method according to claim 1, in which the first probability P₁ⁱ, for the satellite of index i, that the signal received comprises a combination of a non-reflected signal component and of a multi-path signal component, simultaneously uses a delay tracking loop based on a narrow separation early/late discriminant, a delay tracking loop based on a normal separation early/late discriminant, and a discrepancy between the lags evaluated by the said loops.

5. The method according to claim 1, in which the second probability P₂ⁱ, for the satellite of index i, that the signal received comprises solely a multi-path signal component, simultaneously uses a delay tracking loop based on a narrow separation early/late discriminant, a delay tracking loop based on a normal separation early/late discriminant, and a temporal variation of a discrepancy between the lags evaluated by the said loops.

6. The method according to claim 1, in which the third probability P₃ⁱ, for the satellite of index i, that the signal received is jammed by terrestrial interference uses a discrepancy between a measurement of the ratio of the power of the signal received to the power of the noise in the signal received and an expected estimation of the ratio of the power of the signal received to the power of the noise in the signal received.

7. The method according to claim 1, in which the fourth probability P₄ⁱ, for the satellite of index i, that the signal received comprises a combination of a component of a signal generated by a jammer on the ground and of a component of the nominal signal uses a discrepancy between a measurement of pseudo-distance residual and an expected estimation of pseudo-distance residual.

8. The method according to claim 1, in which the fifth probability P₅ⁱ, for the satellite of index i, that the signal received is not in coherence with previous conditions of reception of the said signal uses a variation of the variance of the residuals of the pseudo-distances of the said satellites.

9. The method according to claim 1, in which the sixth probability P₆ⁱ, for the satellite of index i, that the signal received is not in coherence with a mapping of the environs uses a discrepancy between the measured power of the signal received from the satellite of index i and an expected estimation of the power of the signal received from the satellite of index i.

10. A system for determining the position of a system receiver of a satellite navigation system, adapted for implementing the method according to claim 1.
